(19) United States
(12) Patent Application Publication
(10) Pub. No.: US 2015/0023510 A1
(43) Pub. Date: Jan. 22, 2015

(54) Sound Processing System and Sound Processing Device

(71) Applicant: Funai Electric Co., Ltd., Osaka (JP)

(72) Inventor: Noriyuki Shimizu, Osaka (JP)

(73) Assignee: FUNAI ELECTRIC CO., LTD., Osaka (JP)

(21) Appl. No.: 14/336,001

(22) Filed: Jul. 21, 2014

(30) Foreign Application Priority Data
Jul. 22, 2013 (JP) 2013-151728

(51) Int. Cl. H04R 29/00; H04R 1/08; H04R 1/10

(52) U.S. Cl. CPC H04R 29/00; H04R 1/1016; H04R 1/08
USPC 381/58

(57) ABSTRACT

Provided is a sound processing system and a sound processing device, which are capable of detecting attachment/detachment of an earphone microphone without adding a signal wire for detection. The sound processing system includes an earphone microphone and a sound processing device. The earphone microphone includes a speaker and a microphone. The speaker outputs an output sound. The microphone outputs a collected sound signal corresponding to collected sounds, and collects echo sound of the output sound echoed in an external acoustic meatus in a state where the earphone microphone is placed in the external acoustic meatus. The sound processing device includes an attachment determinator, which determines whether or not the earphone microphone is placed in the external acoustic meatus based on a variation of the collected sound signal.

This application is based on Japanese Patent Application No. 2013-151728 filed on Jul. 22, 2013, contents of which are hereby incorporated by reference.

### BACKGROUND OF THE INVENTION

1. Field of the Invention

The present invention relates to a sound processing system, and particularly to a sound processing system including an earphone microphone in which a speaker and a microphone is mounted, and a sound processing device.

2. Description of Related Art

Conventionally, there is known an earphone microphone including a speaker and a microphone. A user who puts on this earphone microphone can transmit his or her voice input to the microphone while hearing sound such as speaking voice output from the speaker. Therefore, the earphone microphone is used for handsfree communication with a smart phone or the like.

On the other hand, the earphone microphone can be used also as a general earphone for listening to music as described in JP-A-2000-182310, for example. Therefore, the user can use the earphone microphone usually for listening to music or the like and can use it as a handset when performing telephone communication.

Here, when listening to music or the like by the earphone microphone, if the earphone microphone is not set to the ear, the user may forget that music is playing. In this case, the user may leave the playing operation without stopping, and hence power is wastefully consumed so that power source may be exhausted. On the other hand, if the user stops the playing operation every time when the earphone microphone is taken off the ear, the power consumption can be prevented, but this operation is very inconvenient for the user.

Concerning this problem, JP-A-2000-182310 describes a structure in which a headphone is provided with a sensor for detecting whether or not the headphone is attached, and a detection signal of the sensor is transmitted to an information reproduction apparatus. When the sensor does not detect that the headphone is attached, the information reproduction apparatus turns down volume or stops reproducing operation. By this operation, wasteful power consumption is suppressed. Here, when the sensor is disposed, it is necessary to add a signal wire for sending the sensor signal to the information reproduction apparatus, and hence an electrode for sending the sensor signal is added to the terminal for connecting the headphone to the information reproduction apparatus. However; such a specialized terminal may not be compatible with an interface adopted by usual communication devices. Therefore, the headphone may not be connected to a communication device such as a smart phone that is widely used at present.

### SUMMARY OF THE INVENTION

The present invention is made in view of the above-mentioned problem, and it is an object of the present invention to provide a sound processing system and a sound processing device, which can detect whether or not an earphone microphone is attached without adding a signal wire for detection.

In order to achieve the above-mentioned object, a sound processing system according to one embodiment of the present invention includes an earphone microphone and a sound processing device. The earphone microphone includes a speaker and a microphone. The speaker outputs an output sound. The microphone outputs a collected sound signal corresponding to collected sound, and collects echo sound of the output sound echoed in an external acoustic meatus in a state where the earphone microphone is placed in the external acoustic meatus. The sound processing device includes an attachment determinator. The attachment determinator determines whether or not the earphone microphone is placed in the external acoustic meatus based on a variation of the collected sound signal.

Further features and advantages of the present invention will become more apparent from the embodiments described below.

### BRIEF DESCRIPTION OF THE DRAWINGS

FIG. 1 is an external perspective view of a sound processing system.

FIG. 2 is a diagram illustrating a state where an earphone microphone is placed in the user's external acoustic meatus.

FIG. 3 is a schematic cross-sectional view of a main body of the earphone microphone placed in the user's ear according to the first embodiment.

FIG. 4 is a block diagram illustrating an internal structure of a, smart phone.

FIG. 5 is a graph illustrating a variation of frequency characteristics of collected sound in accordance with an attachment/detachment state of the earphone microphone.

FIG. 6 is a schematic cross-sectional view of the main body of the earphone microphone placed in the user's ear according to a second embodiment.

FIG. 7 is a schematic cross-sectional view of the main body of the earphone microphone placed in the user's ear according to a third embodiment.

### DETAILED DESCRIPTION OF THE PREFERRED EMBODIMENTS

Now, embodiments of the present invention are described with reference to the drawings.

### First Embodiment

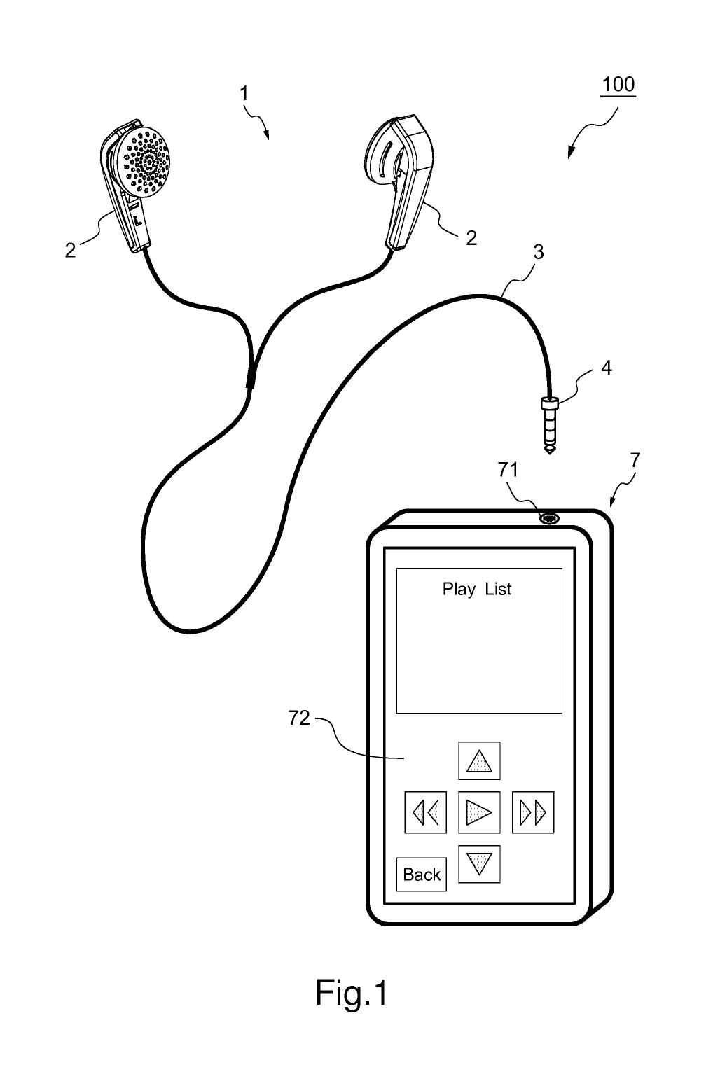

FIG. 1 is an external perspective view of a sound processing system. As illustrated in FIG. 1, in a sound processing system 100, an inner ear type earphone microphone 1 is connected to a smart phone 7. Note that, for easy understanding of a general structure of the earphone microphone 1, FIG. 1 illustrates a state before a plug 4 of the earphone microphone I is connected to an earphone jack 71 of the smart phone 7.

This earphone microphone 1 is a sound input/output device including two main bodies 2, a cable 3, and the four-electrode plug 4. Each main body 2, which is placed in the user's ear, outputs an output sound based on a sound signal sent from the smart phone 7, and collects input sounds (for example, user's speaking voice) from outside. A specific structure of the main body 2 will be described later. The cable 3 is a signal wire connected between each main body 2 and the plug 4. The cable 3 sends and receives signals between each main body 2 of the earphone microphone 1 and the smart phone 7 via the plug 4.

The plug 4 is an input and output terminal to be connected to the earphone jack 71 of the smart phone 7, and includes first to third electrodes and a ground electrode, for example. The first electrode is an electrode through which the sound signal of the output sound to be output from one of the main bodies 2 (for example, one for left ear) is send from the smart phone 7. The second electrode is an electrode through which the sound signal of the output sound to be output from the other main body 2 (for example, the other for right ear) is send from the smart phone 7. The third electrode is an electrode through which the output signal generated in each main body 2 is sent to the smart phone 7. Note that the output signal sent through the third electrode includes a collected sound signal generated based on sound collected by at least one of the main bodies 2.

In addition, the smart phone 7 is portable information communication equipment and is an example of a sound processing device of the present invention. A specific structure of this smart phone 7 will be described later. The smart phone 7 can perform, in addition to telephone communication, various functions using installed applications (transmission and reception of electronic mail, reproduction of music, game, the Internet access, and the like). For instance, when the smart phone 7 performs reproduction of music, two main bodies 2 of the earphone microphone 1 output sound corresponding to the sound signal output from the smart phone 7. In addition, when the smart phone 7 performs telephone communication, one of the main bodies 2 of the earphone microphone 1 collects sound including user's speaking voice, for example, and the output signal generated in accordance with the collected sound is output to the smart phone 7. In addition, the other main body 2 of the earphone microphone 1 outputs sound including speaking voice of the person on the other end based on the sound signal output from the smart phone 7.

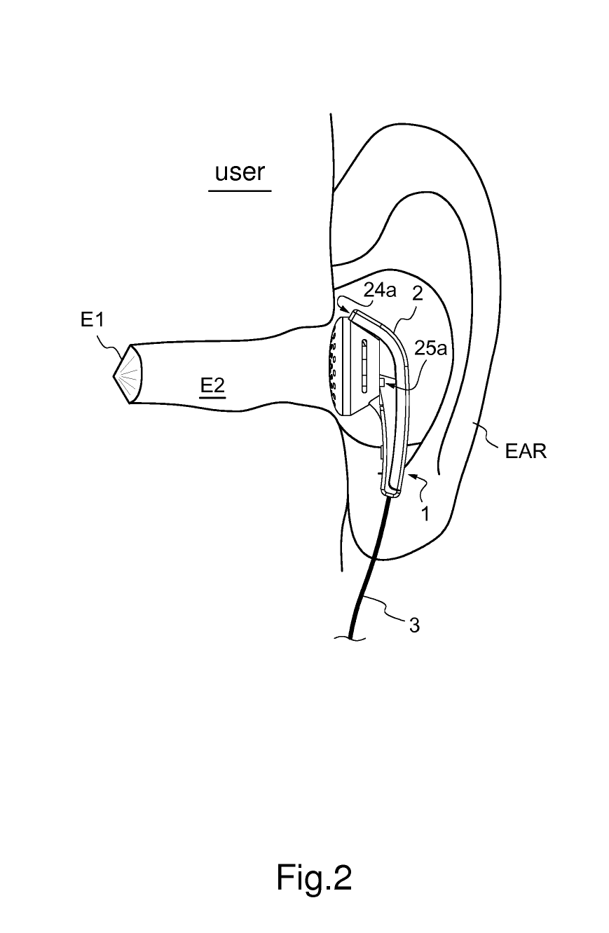

FIG. 2 is a diagram illustrating a state where the earphone microphone is placed in the user's external acoustic meatus. As illustrated in FIG. 2, the main body 2 of the earphone microphone 1 is placed in a user's ear EAR and outputs the output sound based on the sound signal output from the smart phone 7 toward a user's tympanum E1. In addition, the voice sound generated by the user is not only output from the mouth, but a part of the sound is transmitted through the skull, the face muscle, and the like to be output from the tympanum E1 to an external acoustic meatus E2. The earphone microphone 1 collects the input sound such as the user's speaking voice and the like and further generates a sound signal based on the collected sound to output the signal to the smart phone 7.

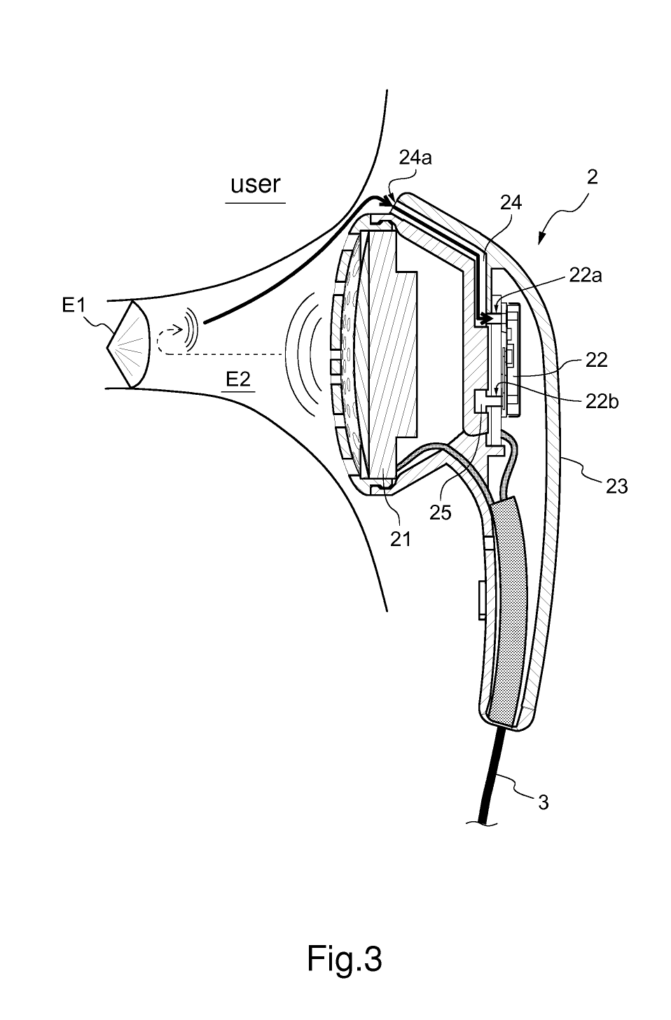

Next, a structure of the main body 2 of the earphone microphone 1 is described in detail. FIG. 3 is a schematic cross-sectional view of the main body of the earphone microphone placed in the user's ear according to the first embodiment. Note that in FIG. 3, a broken line arrow indicates a propagation path of the output sound output from the earphone microphone 1 to the external acoustic meatus E2. In addition, a solid line arrow indicates a propagation path of echo sound of the output sound echoed by the tympanum E1 and the external acoustic meatus E2 until collected by the earphone microphone 1.

As illustrated in FIG. 3, the main body 2 includes a speaker 21, a microphone 22, and a main body case 23.

The speaker 21 is a sound output part that is electrically connected to the cable 3. The speaker 21 outputs the output sound based on the sound signal sent from the smart phone 7 via the cable 3 and the plug 4.

Note that as illustrated by the broken line in FIG. 3, in the state where the main body 2 is placed in the external acoustic meatus E2, the output sound is echoed by the tympanum E1 and the external acoustic meatus E2, but in the inner ear type earphone microphone 1, a gap between the external acoustic meatus E2 and the main body case 23 is not sealed. Therefore, the echo sound of the output sound leaks to the outside through the gap between the external acoustic meatus E2 and the main body case 23.

The microphone 22 is a sound input part that is electrically connected to the cable 3 and includes first and second sound input holes 22a and 22b. The microphone 22 is a differential microphone that collects sound in accordance with a sound pressure difference between the first and second sound input holes 22a and 22b. Note that the microphone 22 is not particularly limited, but a MEMS microphone can be used, for example. The microphone 22 generates a collected sound signal based on the sound pressure difference between the sound input to the first sound input hole 22a and the sound input to the second sound input hole 22b. The generated collected sound signal is delivered to the smart phone 7 via, the cable 3 and the plug 4.

The main body case 23 is a housing in which the speaker 21 and the microphone 22 are mounted. This main body case 23 is provided with a sound input passage 24 and an external communication sound passage 25. One end of the sound input passage 24 is communicated with outside of the main body case 23 via a first opening 24a, and the other end is communicated with the first sound input hole 22a of the microphone 22. Therefore, the sound propagating to the sound input passage 24 through the first opening 24a is guided to the first sound input hole 22a. In addition, one end of the external communication sound passage 25 is communicated with outside of the main body case 23 through a second opening 25a (see FIG. 2), and the other end is communicated with the second sound input hole 22b of the microphone 22. Therefore, the sound propagating to the external communication sound passage 25 through the second opening 25a is guided to the second sound input hole 22a.

Note that in the state where the main body 2 of the earphone microphone 1 is placed in the user's external acoustic meatus E2, the first opening 24a is closer to the external acoustic meatus E2 than the second opening 25a (see FIG. 2). Therefore, the echo sound leaking from the gap between the external acoustic meatus E2 and the main body case 23 propagates to the sound input passage 24 in a shorter distance than the external communication sound passage 25. In addition, sound propagating in an open space such as the outside space of the main body case 23 other than the external acoustic meatus E2 is usually attenuated more than sound propagating in the sound passage. Therefore, the echo sound leaking through the gap between the external acoustic meatus E2 and the main body case 23 is collected by the tint and second sound input holes 22a and 22b of the microphone 22 with a sound pressure difference corresponding to a distance difference between the propagation paths to the first and second openings 24a and 25a. Therefore, the microphone 22 generates the collected sound signal based on sound corresponding to the sound pressure difference between the first and second sound input holes 22a and 22b.

Note that ambient sound (noise) other than the echo sound also propagates to the sound input passage 24 and the external communication sound passage 25. However, the sound input passage 24 and the external communication sound passage 25 are communicated with also the outside of the main body case 23 other than the external acoustic meatus E2. Therefore, the ambient sound is collected by the first and second sound input holes 22a and 22b with substantially the same sound pressure. Therefore, the microphone 22 does not substantially collect the ambient sound. Thus, it is prevented that the noise corresponding to the ambient sound is mixed to the sound collected by the microphone 22.

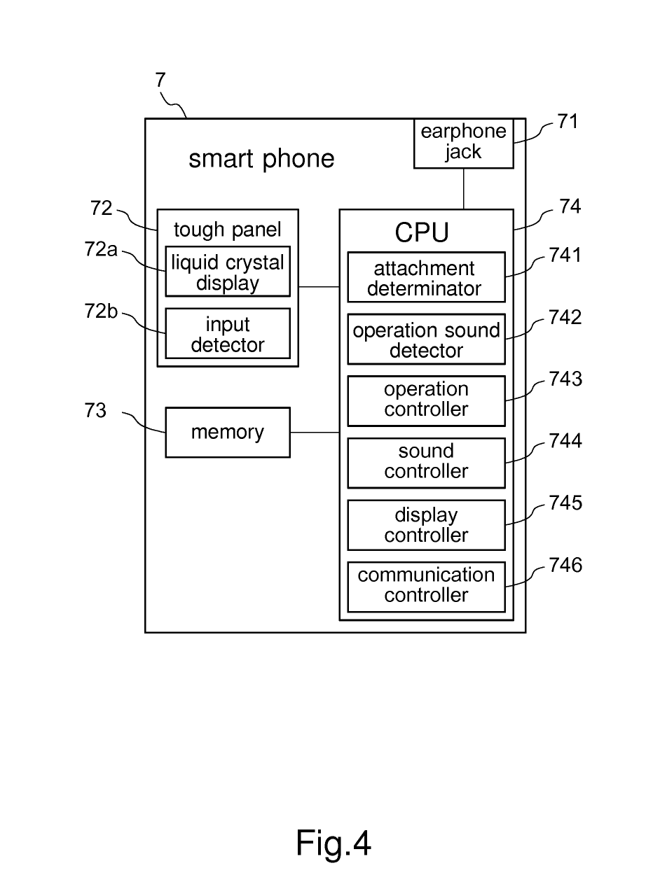

Next, a structure of the smart phone 7 is described. FIG. 4 is a block diagram illustrating an internal structure of the smart phone. As illustrated in FIG. 4, the smart phone 7 includes the earphone jack 71, a touch panel 72, a memory 73, and a CPU 74. Other than that, the smart phone 7 also includes an antenna and a communication part (that are not shown) for realizing a telephone communication function, but description thereof is omitted.

The earphone jack 71 is an input and output terminal to which the plug 4 of the earphone microphone 1 is connected.

The touch panel 72 is a display input part for the user to perform a touch input by touching a display screen with a finger or a touch pen (namely, user operation). The touch panel 72 includes a liquid crystal display 72a and an input detector 72b. The liquid crystal display 72a is a display part that performs display based on a control signal, an image signal, and the like output from the CPU 74. The input detector 72b is an input part that detects a user operation by the touch input based on a movement of an object (for example, the user's finger, the touch pen, or the like) touching the display screen of the touch panel 72.

The memory 73 is a non-volatile storage medium and stores programs and control information used by individual parts of the smart phone 7 (for example, the CPU 74 and the like), operation sound information various sound information and image information in a non-volatile manner. In the operation sound information, various operations are set corresponding to individual operation sound signals described later. In addition, the memory 73 also stores programs for realizing various applications used in the smart phone 7 in a non-temporary manner.

The CPU 74 is a controller that controls individual parts of the smart phone 7. The CPU 74 performs various functions using programs and control information stored in the memory 73. For instance, functional parts of the CPU 74 include an attachment determinator 741, an operation sound detector 742, an operation controller 743, a sound controller 741, a display controller 745, and a communication controller 746.

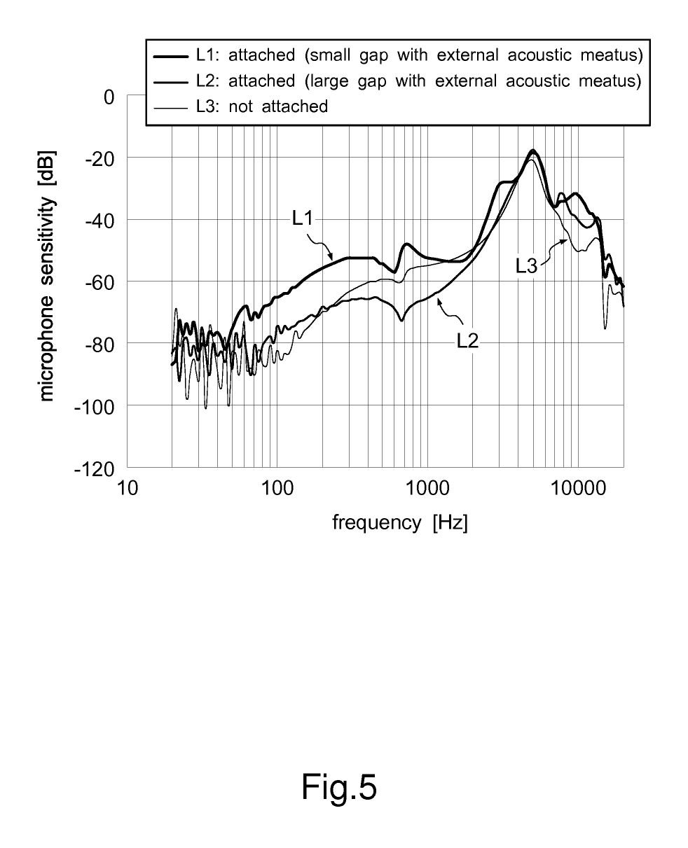

The attachment determinator 741 determines whether or not the earphone microphone 1 is placed in the external acoustic meatus E2 based on a variation of the collected sound signal in a predetermined frequency band. FIG. 5 is a graph illustrating a variation example of frequency characteristics of the collected sound of the attachment/detachment state of the earphone microphone. Note that in FIG. 5, a characteristic line L1 illustrates frequency characteristics of the collected sound signal in a case where the main body 2 of the earphone microphone 1 is placed tightly in the user's ear EAR. A characteristic line L2 illustrates frequency characteristics in a case where the main body 2 is placed loosely in the ear EAR (namely, in a case where a gap between the main body 2 and the external acoustic meatus E2 is wider than the characteristic line L1). A characteristic line L3 illustrates frequency characteristics of the collected sound signal in a case where the main body 2 is not placed in the ear EAR.

As illustrated in FIG. 5, as the main body 2 of the earphone microphone 1 is further from the external acoustic meatus E2, the frequency characteristics of the collected sound signal become lower in a high frequency band (for example, in vicinity of 10,000 Hz) and in a low frequency band (for example, in vicinity of 100 Hz). In this way, even if the output sound from the speaker 21 is the same, the frequency characteristics in the high frequency band and in the low frequency band of the echo sound collected by the microphone 22 becomes lower as the main body 2 becomes farther from the external acoustic meatus E2. Utilizing this phenomenon, the attachment determinator 741 determines that the earphone microphone 1 is detached from the ear EAR if a decrease for a decrease ratio) of sensitivity of the microphone 22 in at least one of the high frequency band and the low frequency band is a threshold value or larger. On the other hand, the attachment determinator 741 determines that the earphone microphone 1 is placed in the ear EAR if a decrease (or a decrease ratio) of sensitivity of the microphone 22 in at least one of the high frequency band and the low frequency band is smaller than the threshold value.

The operation sound detector 742 detects an operation sound signal indicating a predetermined user operation based on the sound signal of the output sound and the collected sound signal. For instance, if the user taps the main body case 23 during reproduction operation of music by the smart phone 7, the impact sound is collected by the microphone 22. Therefore, the collected sound signal generated by the microphone 22 includes a signal component corresponding to the impact sound. The operation sound detector 742 detects the signal component as the operation sound signal. Note that the impact sound has a very narrow frequency band and a high sound pressure compared with the output sound of the speaker 21 and the echo sound thereof. Therefore, it is easy to determine and extract the signal component corresponding to the impact sound by comparing with the sound signal of the output sound.

The operation controller 743 performs a predetermined operation corresponding to a result of the determination by the attachment determinator 741. For instance, when the attachment determinator 741 determines that the earphone microphone 1 is detached from the ear EAR during the reproduction operation of sounds such as music, the operation controller 743 stops the reproduction operation. In this case, the operation controller 743 may finish the active reproduction application or may power off the smart phone 7. Thus, it is possible to suppress wasteful power consumption consumed for the reproduction operation by the application.

In addition, when the operation sound detector 742 detects the operation sound signal, the operation controller 743 reads out the operation sound information from the memory 73. Then, the operation controller 743 refers to the operation sound information so as to perform an operation corresponding to the operation sound signal (for example, a first forward operation, a rewind operation, a stop operation, and the like of the playing music). Note that the operation corresponding to the operation sound signal may be set in accordance with the number of times of the impact sound corresponding to the operation sound signal or may be set in accordance with a generation pattern of a plurality of impact sounds.

The sound controller 714 generates a sound signal based on the sound information stored in the memory 73 and outputs the generated sound signal to the earphone microphone 1 via the earphone jack 71. The display controller 745 controls the touch panel 72 (in particular, a display on the liquid crystal display 72a). In addition, the communication controller 746 controls the communication function of the smart phone 7.

The first embodiment of the present invention is described above. The sound processing system 100 of the first embodiment includes the inner ear type earphone microphone 1 and the smart phone 7 to which the earphone microphone 1 is connected. The earphone microphone 1 includes the speaker 21 and the microphone 22. The speaker 21 outputs the output sound based on the sound signal. The microphone 22 outputs the collected sound signal corresponding to the collected sound, and collects the echo sound of the output sound echoed in the external acoustic meatus E2 in the state where the earphone microphone 1 is placed in the external acoustic meatus E2. In addition, the smart phone 7 includes the attachment determinator 741. The attachment determinator 741 determines whether or not the earphone microphone 1 is placed in the external acoustic meatus E2 based on a variation of the collected sound signal.

In this way, in the state where the earphone microphone 1 is placed in the user's external acoustic meatus E2, the microphone 22 collects the echo sound of the output sound of the speaker 21 echoed in the external acoustic: meatus E2 and outputs the collected sound signal corresponding to the collected sound. Here, the frequency characteristics of the collected sound output from the microphone 22 are different between the case where the earphone microphone 1 is placed in the user's external acoustic meatus E2 and the case where the earphone microphone 1 is not placed in the same. For instance, in the inner ear type earphone microphone 1, a gap between the earphone microphone 1 and the external acoustic meatus E2 is not sealed. Therefore, the microphone 22 can hardly collect the echo sound in the high frequency band (for example, in vicinity of 10,000 Hz) and in the low frequency band (for example, in vicinity of 100 Hz) (see FIG. 5). Therefore, the collected sound signal also varies in the same manner. The attachment determinator 741 of the smart phone 7 can determine whether or not the earphone microphone 1 is placed in the user's external acoustic meatus E2 based on the variation of the collected sound signal without using a sensor. Therefore, it is possible to detect attachment/detachment of the earphone microphone 1 without adding a signal wire for detection.

Further, it is possible to eliminate a space for disposing a sensor and the like in the earphone microphone 1. Therefore, flexibility in designing the structure of the earphone microphone 1 can be improved, and downsizing of the earphone microphone 1 can be achieved. In addition, because a sensor and the like are not necessary, manufacturing cost can also be reduced.

In addition, according to the first embodiment, the attachment determinator 741 determines whether or not the earphone microphone 1 is placed in the external acoustic meatus E2 based on a variation of the collected sound signal in a predetermined frequency band. In this way, it is possible to determine more correctly whether or not the earphone microphone 1 is placed in the user's external acoustic meatus E2 based on a variation of the collected sound signal in a frequency band in which the variation is particularly conspicuous. Alternatively, it is possible to determine based on a variation of the collected sound signal in a frequency band other than the frequency band of sound (such as human voice) that is mainly used in handsfree communication or the like of the earphone microphone 1. Therefore, it is possible to achieve both the function of suppressing collection of the echo sound of the output sound such as human voice communicating by the earphone microphone 1 and the function of detecting attachment/detachment of the earphone microphone 1.

In addition, according to the first embodiment, the earphone microphone 1 further includes the main body case 23 in which the sound input passage 24 and the external communication sound passage 25 are formed. The sound input passage 24 permits the echo sound of the output sound echoed in the external acoustic meatus E2 to propagate to the microphone 22. The external communication sound passage 25 is communicated with the outside of the main body case 23 other than the external acoustic meatus E2 in the state where the earphone microphone 1 is placed in the external acoustic meatus E2. In addition, the microphone 22 is a differential microphone including the first sound hole 22a communicating with the sound input passage 24 and the second sound hole 22b communicating with the external communication sound passage 25. In this way, the sound pressure of ambient sound (so-called noise) propagating from outside of the main body case 23 other than the external acoustic meatus E2 is substantially the same between the first and second sound input holes 22a and 22b. Therefore, the microphone 22 does not substantially collect the ambient sound. Therefore, it is possible to prevent noise corresponding to the ambient sound from being added to the collected sound signal output by the microphone 22.

In addition, according to the first embodiment, the smart phone 7 further includes the sound controller 744, the operation sound detector 742, the memory 73, and the operation controller 743. The sound controller 744 outputs the sound signal for the speaker 21 to output the output sound. The operation sound detector 742 detects the operation sound signal generated by a predetermined user operation based on the sound signal and the collected sound signal. The memory 73 stores the operation sound information in which the operations corresponding to the operation sound signals are set. When the operation sound signal is detected, the operation controller 743 executes the operation corresponding to the operation sound signal based on the operation sound information. In this way, when a user's finger taps the earphone microphone 1 in a predetermined pattern, for example, the operation sound signal corresponding to the impact sound is detected based on the sound signal of the output sound from the speaker 21 and the collected sound signal. When the operation sound signal is detected, the operation corresponding to the operation sound signal (for example, a fast forward operation, a rewind operation, a stop operation, and the like of the playing music) is executed based on the operation sound information. Therefore, the user can use the smart phone 7 to perform various operations by intuitive operation.

### Second Embodiment

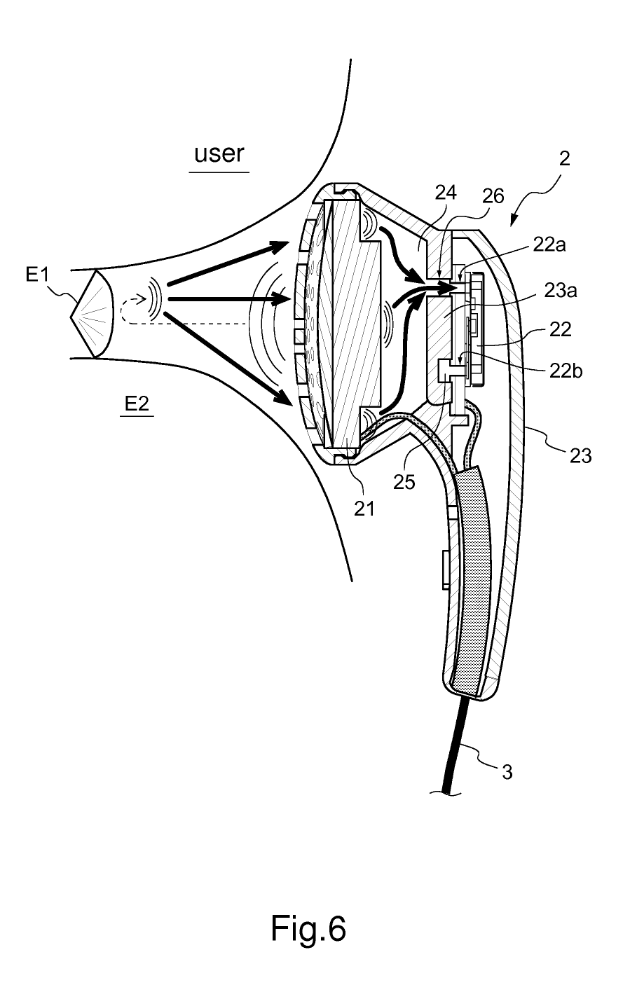

Next, the earphone microphone 1 according to a second embodiment is described. FIG. 6 is a schematic cross-sectional view of a main body of the earphone microphone placed in the user's ear according to the second embodiment. In the second embodiment, instead of the sound input passage 24 and the first opening 24a, a third opening 26 is formed in a partition 23a separating the speaker 21 from the microphone 22. In addition, a space between the speaker 21 and the partition 23a functions as the sound input passage 24 and is communicated with the first sound input hole 22a through the third opening 26. Other than that is the same as the first embodiment. In the following description, the same structural element as the first embodiment is denoted by the same numeral or symbol, and description thereof is omitted.

Note that in FIG. 6, a broken line arrow indicates a propagation path of the output sound from the earphone microphone 1 to the external acoustic meatus E2. In addition, a solid line arrow indicates a propagation path of the echo sound of the output sound echoed by the tympanum E1 and the external acoustic meatus E2 until being collected by the earphone microphone 1.

As illustrated in FIG. 6, in the state where the main body 2 of the earphone microphone 1 is placed in the user's ear EAR, the echo sound of the output sound echoed by the tympanum E1 and the external acoustic meatus E2 propagates to the backside of the speaker 21 after passing through the speaker 21. This echo sound propagates in the space 24 on the backside of the speaker 21 and in the third opening 26 so as to be collected at the first sound input hole 22a. Here, the speaker 21 outputs the output sound mainly to the outside of the main body case 23 (in particular, the external acoustic meatus E2), and the backside of the speaker 21 also output the output sound having a relatively low sound pressure (hereinafter, referred to as backside sound). Therefore, the first sound input hole 22a collects the backside sound in addition to the echo sound. Therefore, in the state where the main body 2 of the earphone microphone 1 is placed in the user's ear EAR, the microphone 22 generates the collected sound based on the echo sound and the backside sound.

On the other hand, when the main body 2 is not placed in the ear EAR, the microphone 22 generates the collected sound substantially based on the backside sound. Therefore, when the main body 2 of the earphone microphone 1 is separated from the external acoustic meatus E2, frequency characteristics of the collected sound signal varies similarly to FIG. 5, for example.

Therefore, the attachment determinator 741 can determine whether or not the earphone microphone 1 is placed in the external acoustic meatus E2 based on a variation of the collected sound signal in a predetermined frequency band. Therefore, the operation controller 743 can stop the reproduction operation of the smart phone 7 based on a result of detection by the attachment determinator 741 so that wasteful power consumption can be suppressed.

### Third Embodiment

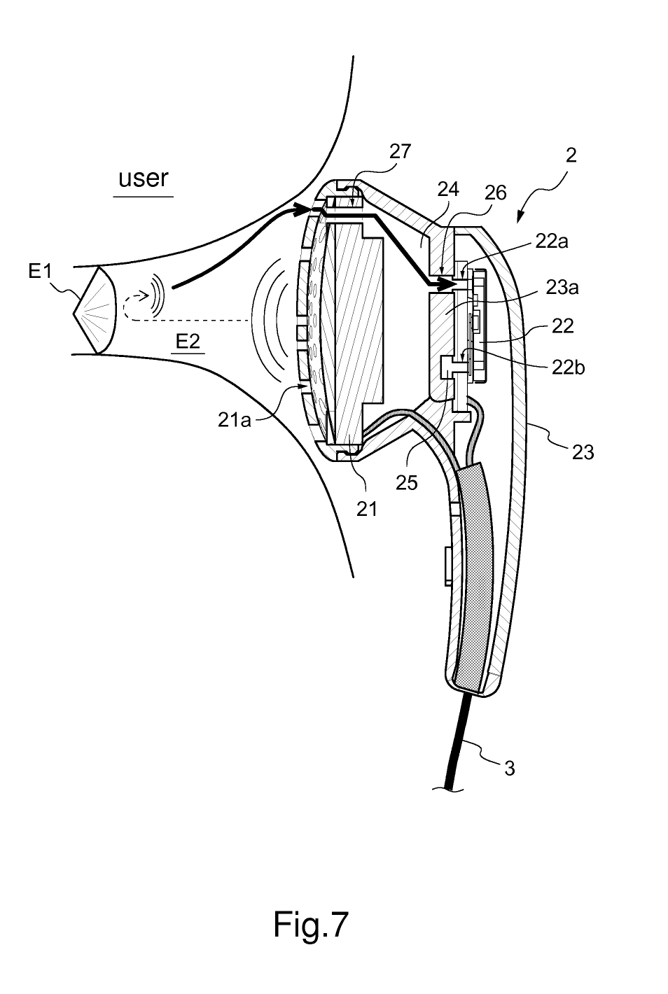

Next, the earphone microphone 1 of a third embodiment is described. FIG. 7 is a schematic cross-sectional view of the main body of the earphone microphone placed in the user's ear according to the third embodiment. In the third embodiment, there is formed a through hole 27 communicating between a sound output surface 21a and the backside space of the speaker 21. In addition, the space between the speaker 21 and the partition 23a and the through hole 27 function as the sound input passage 24 and are communicated with the first sound input hole 22a through the third opening 26. Other than that is the same as the second embodiment. The same structural element as the second embodiment is denoted by the same numeral or symbol, and description thereof is omitted.

Note that in FIG. 7, a broken line arrow indicates a propagation path of the output sound from the earphone microphone 1 to the external acoustic meatus E2. In addition, a solid line arrow indicates a propagation path of the echo sound of the output sound echoed by the tympanum E1 and the external acoustic meatus E2 until being collected by the earphone microphone 1.

As illustrated in FIG. 7, in the state where the main body 2 of the earphone microphone 1 is placed in the user's ear EAR, the echo sound of the output sound echoed by the tympanum E1 and the external acoustic meatus E2 propagates to the backside of the speaker 21 via the through hole 27. This echo sound propagates in the backside space of the speaker 21 (sound input passage 24) and the third opening 26 and is collected by the first sound input hole 22a. Other than that, the first sound input hole 22a also collects output sound from the sound output surface 21a via the through hole 27 to propagate around (hereinafter, referred to as sneak sound) and the backside sound of the speaker 21. Then, the microphone 22 generates the collected sound based on the echo sound, the sneak sound, and the backside sound.

On the other hand, when the main body 2 is not placed in the ear EAR, the echo sound does not reach the first sound input hole 22a so that the microphone 22 generates the collected sound substantially corresponding to the sneak sound and the backside sound. Therefore, when the main body 2 of the earphone microphone 1 is separated from the external acoustic meatus E2, the frequency characteristics of the collected sound signal vary similarly to FIG. 5, for example.

Therefore, the attachment determinator 741 can determine whether or not the earphone microphone 1 is placed in the external acoustic meatus E2 based on a variation of the collected sound signal in a predetermined frequency band. Therefore, because the operation controller 743 can stop reproduction operation or the like of the smart phone 7 in accordance with a result of the determination by the attachment determinator 741, wasteful power consumption can be suppressed.

The third embodiment of the present invention is described above. According to the third embodiment, the sound input passage 24 is communicated with the external acoustic meatus E2 in the state where the earphone microphone 1 is placed in the external acoustic meatus E2. In this way, the echo sound of the output sound echoed in the external acoustic meatus E2 can directly propagate from the external acoustic meatus E2 to the sound input passage 24. Therefore, the microphone 22 can collect clearer echo sound. Therefore, the attachment determinator 741 can detect attachment/detachment of the earphone microphone 1 to the external acoustic meatus E2 more correctly.

As described above, the embodiments of the present invention are described. Note that the embodiments described above are examples, and the combination of structural elements and processes thereof can be modified variously within the scope of the present invention as understood by a skilled person in the art.

For instance, in the first to third embodiments described above, the microphone 22 having two sound input holes is mounted in the main body case 23, but applications of the present invention are not limited to this example. The microphone 22 may include a first microphone having the first sound input hole 22a and a second microphone having the second sound input hole 22b. As the first and second microphones, an ECM microphone or the like can be used, for example. In addition, the earphone microphone 1 may generate the collected sound signal by a control circuit (not shown) based on output signals of the first and second microphones. Alternatively, the sound controller 711 of the smart phone 7 may generate the collected sound signal based on the output signals of the first and second microphones.

In addition, in the first to third embodiments described above, a frequency band in a human audible range is used for determining attachment/detachment of the earphone microphone 1, but applications of the present invention are not limited to this example. It is possible to use a microphone that can collect sound in a frequency band other than the audible range, so as to determine whether or not the earphone microphone 1 is placed in the external acoustic meatus E2 based on a variation of the collected sound signal in a predetermined frequency band other than the human audible range.

In addition, in the first to third embodiments described above, the first opening 24a, the second opening 25a, and the through hole 27 are communicated with the outside of the main body case 23, and a dust-proof member (not shown) may be provided to at least one of them. In addition, the dust-proof member may be disposed inside the opening or may be attached to the opening. In this way, the dust-proof member can prevent dust from flowing into the main body case 23. Further, as the dust-proof member, mesh, sponge, felt, porous film, and the like can be used, for example. In addition, material of the dust-proof member is not particularly limited, but resin such as nylon, polyimide, or the like can be used, for example.

For instance, in the first to third embodiments described above, the attachment determinator 741, the operation sound detector 742, the operation controller 743, the sound controller 744, the display controller 745, and the communication controller 746 are realized as functional parts of the CPU 74, but applications of the present invention are not limited to this example. At least one of them may be realized as a physical element different from the CPU 74 (for example, an electric circuit or the like). Further, at least one of them may be an independent element.

In addition, in the first to third embodiments described above, the earphone microphone 1 includes two main bodies 2, but the present invention is not limited to this structural example. The main body 2 may be a single one.

In addition, in the first embodiment described above, the earphone microphone 1 is the inner ear type, but the present invention is not limited to this structural example. In the first embodiment, the earphone microphone 1 may be a canal type, and may include an ear pad (seal member) for sealing a gap between the main body 2 and the external acoustic meatus E2 when the main body 2 is placed in the external acoustic meatus E2. In this way, in the state where the main body 2 is placed in the ear EAR, the echo sound of the output sound echoed by the tympanum E1 and the external acoustic meatus E2 is not collected by the microphone 22. Therefore, attachment/detachment of the earphone microphone 1 can be easily detected.

In addition, in the first to third embodiments described above, the smart phone 7 is exemplified as a sound processing device of the present invention, but applications of the present invention are not limited to this example. The sound processing device of the present invention can be widely applied to electronic equipment such as a cellular phone, a personal computer, a PDA, and the like having a sound application, and an audio equipment such as an MP3 player, for example.

What is claimed is:

1. A sound processing system comprising:
an earphone microphone including a speaker configured to output an output sound, and a microphone: configured to output a collected sound signal corresponding to collected sounds, so that the microphone collects an echo sound of the output sound echoed in an external acoustic meatus in a state where the earphone microphone is placed in the external acoustic meatus; and
a sound processing device including an attachment determinator configured to determine whether or not the earphone microphone is placed in the external acoustic meatus based on a variation of the collected sound signal.

2. The sound processing system according to claim 1, wherein the attachment determinator determines whether or not the earphone microphone is placed in the external acoustic meatus based on a variation of the collected sound signal in a predetermined frequency band.

3. The sound processing system according to claim 1, wherein
the earphone microphone further includes a main body case in which a sound input passage and an external communication sound passage are formed,
the sound input passage permits: the echo sound to propagate to the microphone,
the external communication sound passage is communicated with outside of the main body case other than the external acoustic meatus in a state where the earphone microphone is placed in the external acoustic meatus, and
the microphone is a differential microphone having a first sound hole communicating with the sound input passage and a second sound hole communicating with the external communication sound passage.

4. The sound processing system according to claim 3, wherein the sound input passage is communicated with the external acoustic meatus in the state where the earphone microphone is placed in the external acoustic meatus.

5. The sound processing system according to claim 1, wherein the sound processing device further includes:
a sound controller configured to output a sound signal for causing the speaker to output the output sound;
an operation sound detector configured to detect an operation sound signal generated by a predetermined user operation based on the sound signal and the collected sound signal;
a memory for storing operation sound information in which an operation corresponding to the operation sound signal is set; and
an operation controller configured to execute an operation corresponding to the operation sound signal based on the operation sound information when the operation sound signal is detected.

6. A sound processing device comprising:
a terminal connected to an earphone microphone including a speaker configured to output an output sound, and a microphone configured to output a collected sound signal corresponding to collected sounds, so that the microphone collects an echo sound of the output sound echoed in an external acoustic meatus in a state where the earphone microphone is placed in the external acoustic meatus; and
an attachment determinator configured to determine whether or not the earphone microphone is placed in the external acoustic meatus based on a variation of the collected sound signal.
